(19) United States
(12) Patent Application Publication
(10) Pub. No.: US 2009/0142642 A1
(43) Pub. Date: Jun. 4, 2009

(54) Cathode structures for solid oxide fuel cells

(76) Inventors: Friedrich B. Prinz, Woodside, CA (US); Suk-Won Cha, Seoul (KR); Kevin M. Crabb, Palo Alto, CA (US); Yuji Saito, Tokyo (JP); Masayuki Sugawara, Palo Alto, CA (US)

Correspondence Address: LUMEN PATENT FIRM, 2345 YALE STREET, SECOND FLOOR, PALO ALTO, CA, 94306, US

(21) Appl. No.: 12/008,714

(22) Filed: Jan. 10, 2008

Related U.S. Application Data
(60) Provisional application No. 60/880,285, filed on Jan. 12, 2007.

(51) Int. Cl. H01M 8/10

(52) U.S. Cl. 429/33; 429/30

(57) ABSTRACT

Cathode structures for low temperature solid oxide fuel cells are provided. The cathode structures include thin dense mixed ionic electronic conducting (MIEC) films. MIEC materials include materials with perovskite structures, such as LSCF. The thickness of the MIEC film is determined by minimizing the sum of the electronic and ionic resistances. Specific functions for the electronic and ionic resistances in terms of device and physical parameters are also provided. Pulsed laser deposition is used for the fabrication of the MIEC film and the electrolyte layer.

### CROSS-REFERENCE TO RELATED APPLICATIONS

This application claims priority from U.S. Provisional Patent Application 60/880285 filed Jan. 12, 2007, which is incorporated herein by reference.

### FIELD OF THE INVENTION

The invention relates generally to solid oxide fuel cells. More particularly, the present invention relates to dense mixed ionic electronic conducting thin film cathodes for solid oxide fuel cells.

### BACKGROUND

Solid oxide fuel cells (SOFCs) are devices capable of efficiently converting chemical energy into useful electrical energy. Conventional materials typically used for important components of SOFCs, especially the cathode and electrolyte, have conductivities that are approximately exponential with the operational temperature of the SOFCs. For this reason, current SOFCs operate at very high temperatures, ranging from about 800 C to 1000 C. At these operational temperatures, ancillary components, especially sealants, become difficult and expensive to manage causing difficulties for the reliability of SOFCs.

Current SOFC technology typically uses porous materials that have little or no ionic conduction for the electrodes. In particular, porous LaMnO₃ is commonly used as the cathode material. Because LaMnO₃ is largely an electronic-only conductor, high porosity is critical for increasing the number of active regions for oxygen reduction in the electrochemical conversion.

In addition to being composed of porous materials, the cathodes of current SOFCs are generally thick, with the thickness ranging from about 10 to 100 microns. The thickness of electrolyte layers for existing SOFCs has a similar range. The geometry and dimensions of SOFCs can affect the performance of the fuel cell. However effects due to changes to the design of the SOFCs can be complicated, requiring trial and error to improve the fuel cell. In particular, the specific effects of changing the thickness of the cathode for fuel cell performance can be difficult to determine. The present invention addresses the problem of electrochemical conversion by SOFCs at reduced temperatures.

### SUMMARY OF THE INVENTION

The present invention advances the art with thin dense mixed ionic electronic conducting cathode structures for solid oxide fuel cells (SOFCs). The present invention is directed to a SOFC with an anode, an electrolyte layer, and a cathode layer, where the cathode layer includes a dense mixed ionic electronic conducting (MIEC) film. The thickness of the MIEC film is determined by a minimization of the sum of the electronic resistance and the ionic resistance, where the electronic resistance is along the plane of the MIEC film and the ionic resistance is across the thickness of the MIEC film.

The electronic resistance of the MIEC film generally decreases with the thickness of the MIEC film, whereas the ionic resistance increases with the MIEC film thickness. Due to this qualitative difference in thickness dependence between the electronic and ionic resistances, a minimum resistance exists for the sum of the two resistances. The optimal thickness is defined by the thickness where this minimum resistance occurs. More particularly, the electronic resistance can be inversely proportional to the thickness and the ionic resistance can be proportional to the thickness.

The present invention also provides specific functions for the electronic and ionic resistances, where the specific functions depend on the MIEC film thickness, electronic and ionic conductivities of the materials, the active fuel cell area, the average distance traveled by an electron, and the width of an electron conduction path. These parameters can be calculated, estimated, or measured. In an embodiment of the present invention, the MIEC film has a thickness ranging from about 10 nm to about 100 nm, preferably about 40 nm to about 50 nm. The MIEC film of the present invention can include a perovskite material, preferably a lanthanum strontium cobalt iron oxygen (LSCF) material. The LSCF material can have the composition La_{0.6}Sr_{0.4}Co_{0.2}Fe_{0.8}O_{3-δ}. The MIEC can be fabricated using pulsed laser deposition. Any suitable material can be used for the electrolyte layer, including yttria-stabilized zirconia. Similar to the cathode layer, the electrolyte layer can be a thin film, preferably ranging in thickness from about 50 nm to about 200 nm.

The cathode layer of the present invention can also include a porous platinum layer in contact with the MIEC film. The porous platinum layer acts as a catalyst for oxygen reduction and can reduce the optimal thickness. The porous platinum is not necessarily interconnected.

### BRIEF DESCRIPTION OF THE FIGURES

The present invention together with its objectives and advantages will be understood by reading the following description in conjunction with the drawings, in which:

FIG. 1 shows an example of a solid oxide fuel cell structure according to the present invention.

FIG. 2 shows an example of an electronic-only conducting cathode of conventional fuel cells.

FIG. 3 shows an example of a mixed ionic electronic conducting (MIEC) cathode according to the present invention.

FIG. 4 shows the conduction paths for the electrons and the ions in an example cathode according to the present invention.

FIG. 5 shows plots of predicted resistance versus LSCF thickness for example fuel cells according to the present invention.

FIG. 6 shows a plot of peak power density versus LSCF thickness measured for low temperature fuel cells of the present invention.

FIG. 7 shows an example of a fuel cell structure with a porous platinum layer according to the present invention.

### DETAILED DESCRIPTION OF THE INVENTION

Fuel cells convert chemical energy into electrical energy with high efficiency. However, conventional solid oxide fuel cells (SOFCs) operate at a very high temperature, which poses difficulties with ancillary components and device reliability. Below is a detailed description of cathode structures for reducing the operational temperature of SOFCs.

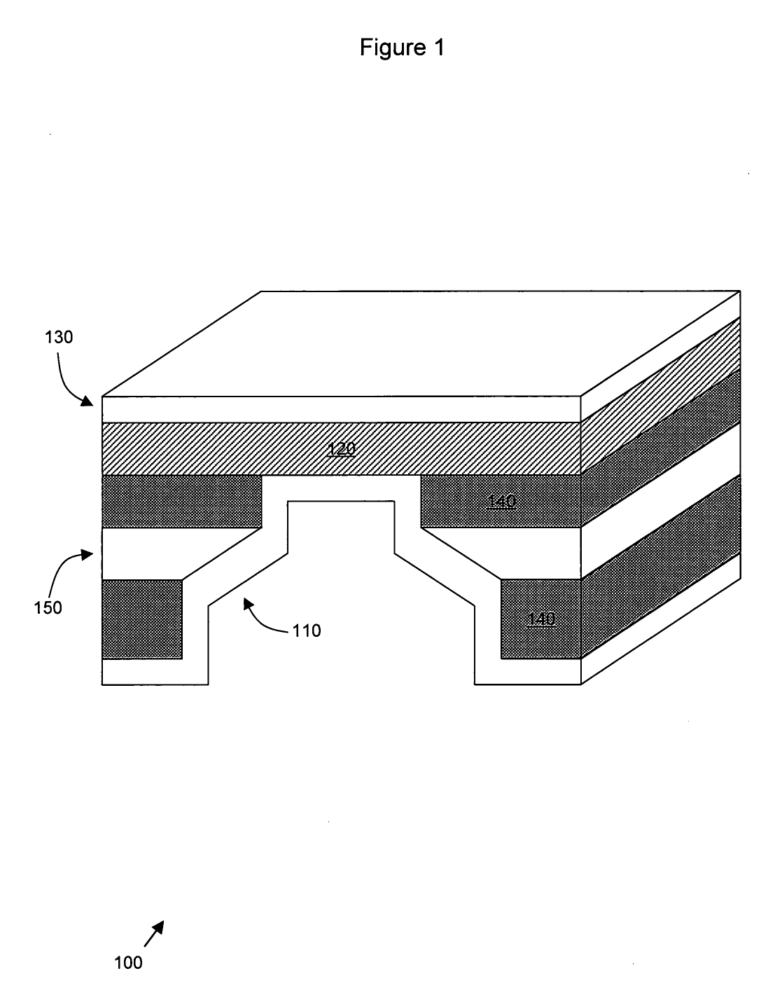

FIG. 1 shows the structure of an example of a solid oxide fuel cell 100. The fuel cell 100 includes three main components: an anode 110, an electrolyte layer 120, and a cathode layer 130. A surface of the electrolyte layer 120 is in contact with the anode 110 and another surface of the electrolyte layer 120 is in contact with the cathode layer 130. In the present invention, the anode 110 can have any geometry and dimension and can be any conducting material that is suitable for a fuel electrode. Though the anode 110, electrolyte 120, and cathode 130 are necessary for electrochemical conversion in a fuel cell, SOFCs can also include silicon nitride layers 140 and a double-sided silicon wafer 150 for support. A function of the electrolyte layer 120 in a fuel cell 100 is to conduct ions from the cathode layer 130 to the anode 110. The electrolyte layer 120 generally has a high electronic resistance and is impermeable to gases, particularly fuel gas and air. Any suitable material can be used as an electrolyte for the present invention, including gadolinium-doped ceria and, preferably, yttria-stabilized zirconia (YSZ). The electrolyte layer 120 can have any size and geometry. In a preferred embodiment, the electrolyte layer 120 is a thin film having a thickness ranging from about 50 nm to about 200 nm.

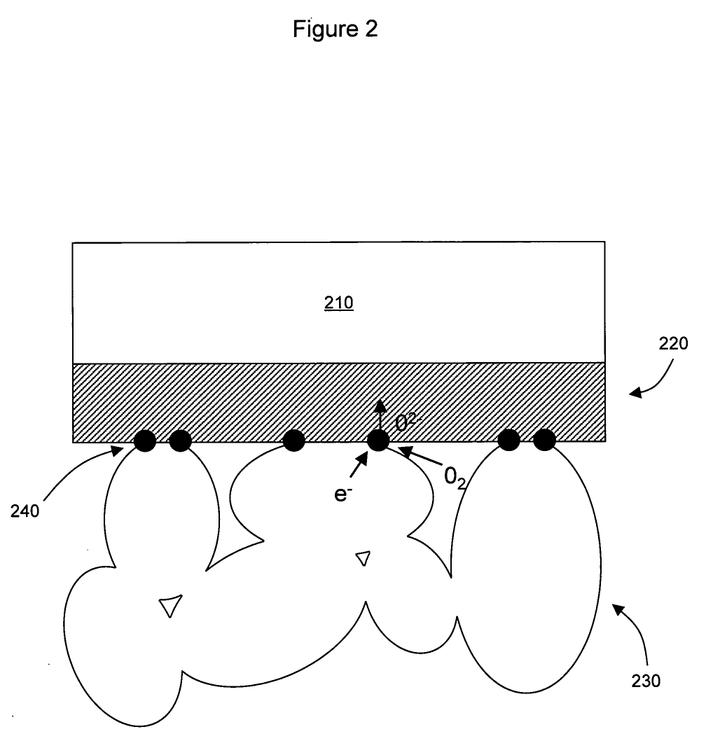

The cathode layer 130 of the present invention includes a dense thin mixed ionic electronic conducting (MIEC) film. Fuel cell electrodes composed of MIEC materials have distinct advantages over standard electronic-only conductors. FIG. 2 shows a SOFC with an electronic-only conducting cathode 230. A fuel cell with an electronic-only conducting cathode 230 requires the presence of a large number of triple phase boundary (TPB) points 240 where the oxygen gas 02 can combine with the electrons e¹ in the cathode to form oxygen ions O¹⁻°in the electrolyte 220. Traditionally, porous materials are used for the SOFC cathode to increase the number of TPB points 240.

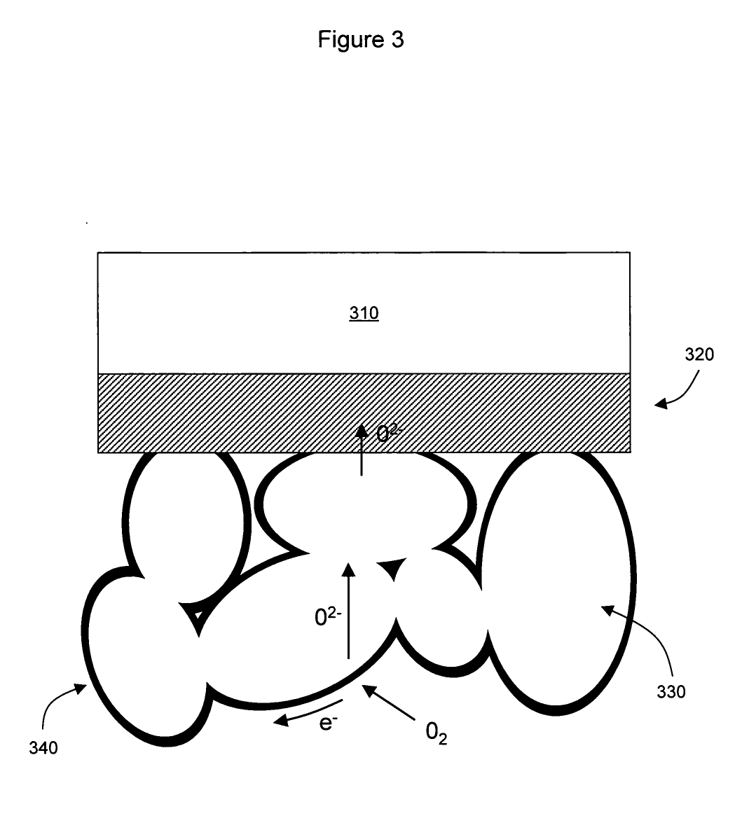

In contrast, MIEC cathodes reduce or eliminate the requirement of large numbers of TPB points 240. FIG. 3 shows a SOFC with a MIEC cathode 330. Because a MIEC cathode 330 conducts ions in addition to electrons, any gas-MIEC boundary 340 can serve as a site for oxygen reduction to an oxygen ion O₂₋, in contrast to the reliance on TPB points 240 for a fuel cell with an electronic-only conducting cathode 230. After oxygen reduction at the gas-MIEC boundary 340, the oxygen ions travel through the MIEC cathode 330 to the electrolyte 320. Ion transport in the MIEC cathode 330 is predominantly through diffusion-dominated processes.

Perovskite materials, such as lanthanum cobalt oxide, have excellent MIEC properties. The MIEC films used in the cathodes of the present invention can be a perovskite, particularly lanthanum strontium cobalt oxide (LSCF). The preferred composition of LSCF is La_{0.6}Sr_{0.4}Co_{0.2}Fe_{0.8}O_{3-δ}, where δ represents the oxygen non-stoichiometry and is determined by the relative amounts of the other compounds.

Thin films in the SOFC can be fabricated using any fabrication process, including pulsed laser deposition (PLD). PLD utilizes pulses of laser energy to ablate a bulk sample of the material of interest. A plume of the ablated material is deposited onto a substrate to form a uniform thin film with essentially the same composition as the bulk sample. PLD can be used to fabricate a thin film electrolyte layer, especially a YSZ layer, and a thin film cathode layer, especially a LSCF layer.

It is important to note that when a cathode is an MIEC cathode, the cathode material need not be porous. In the present invention, the cathode layer 130 includes a thin dense MIEC film. Another important aspect of the present invention is the determination of the thickness of the MIEC film based on the sum of the electronic Rₑ and ionic Rᵢ resistances of the MIEC film.

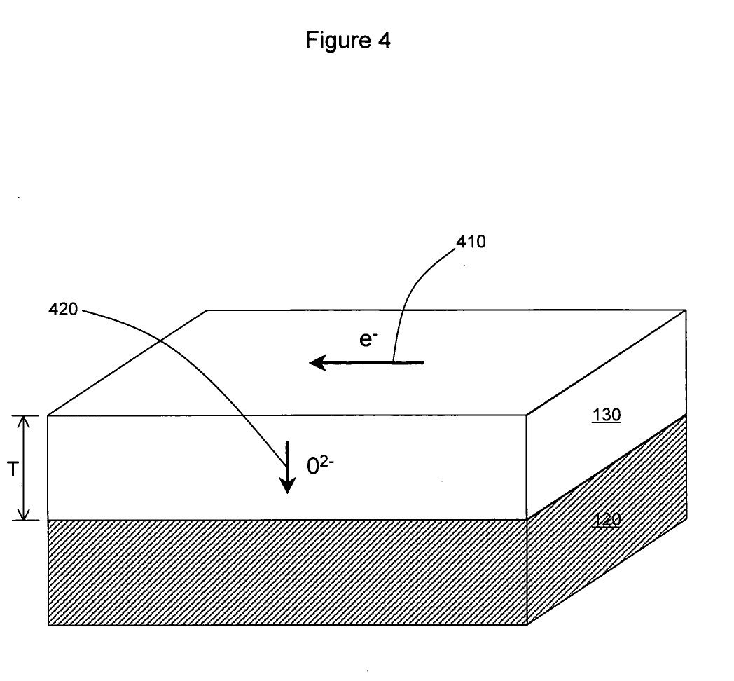

FIG. 4 shows the dominant paths for electronic and ionic conduction through the MIEC cathode layer 130 with thickness T. The electronic conductivity is in the plane 410 of the MIEC film 130 and the ionic conductivity is across 420 the thickness T of the MIEC film 130.

The electronic Rₑ and ionic Rᵢ resistances depend on the thickness T. Generally, the electronic resistance Rₑ decreases with the thickness T and the ionic resistance Rᵢ increases with thickness T, therefore an optimal thickness exists for the sum of Rᵢ and Rₑ. This optimal thickness can be found by finding the minima of the sum of Rᵢ and Rₑ, i.e. by setting the derivative of the sum of Rᵢ and Rₑ with respect to T equal to zero and solving for T.

Functions other than the sum of Rᵢ and Rₑ can be used to find the optimal thickness. The functions have the constraint that at least one minimum must exist. Examples of other functions include fᵢ(Rᵢ)+fₑ(Rᵢ) and g(Rᵢ,Rₑ). However, in the present invention, the minimization of the sum of Rᵢ and Rₑ, is preferred over these alternatives.

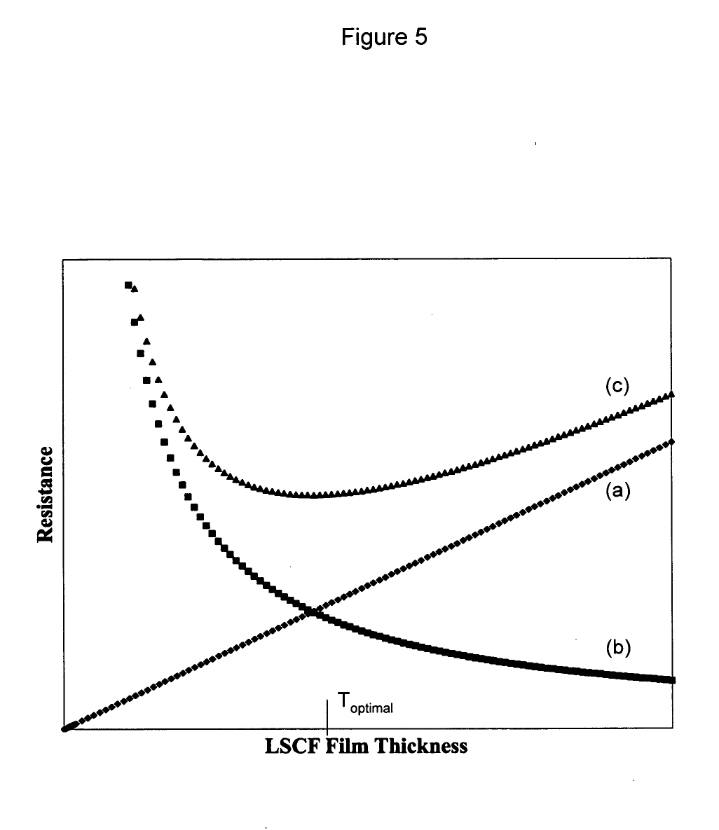

The electronic and ionic resistances depend on physical parameters and the geometry of the device. The physical and device parameters can include the electronic conductivity σₑ, the ionic conductivity cas, an active fuel cell area A, an average distance traveled by an electron D, a width of an electron conduction path C, and the thickness of the MIEC film T. Each of these parameters can be estimated, calculated, or experimentally measured. In a preferred embodiment, the electronic and ionic resistances are given by the equations Rₑ=D/(TCσₑ) and Rᵢ=T/(Aσᵢ). The parameters A, D, C, and the conductivities can depend on the thickness T. However, when D, C, and σₑ do not depend on T, the electronic resistance Rₑ is inversely proportional to T. Correspondingly, when A and as are independent of the thickness T, the ionic resistance is proportional to T. FIG. 5(a) shows a plot of the ionic resistance Ri increasingly linearly with film thickness T. FIG. 5(b) shows a plot of the electronic resistance decreasing with film thickness T.

FIG. 5(c) shows a plot of the sum of Rₑ and Rᵢ versus thickness T, where a minimum resistance exists due to the increasing function Rᵢ and the decreasing function Rₑ. The minimum is located at the optimal thickness Tₒₚₜᵢₘₐₗ. In the example where Rₑ=D/(TCσₑ) and Rᵢ=T/(Aσᵢ) and the parameters A, D, C and the electronic and ionic conductivities are independent of T, the optical thickness Tₒₚₜᵢₘₐₗ=[(ADσᵢ)/(Cσₑ)]^{1/2}.

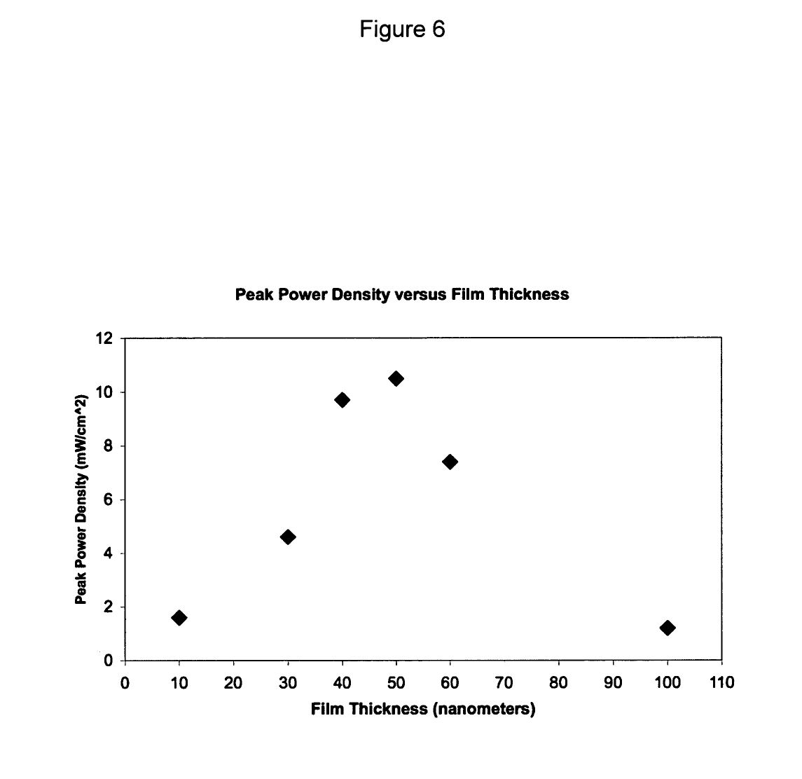

FIG. 6 shows a plot of the measured peak power density for six SOFCs operating at approximately 350 C. These low temperature SOFCs have thin dense LSCF film cathodes with LSCF film thicknesses ranging from 10 nm to 100 nm. The plot in FIG. 6 clearly shows 15 a maximum in peak power density when the LSCF film has a thickness of about 40 nm to about 50 nm. A YSZ layer with a thickness of about 100 nm was used as the electrolyte. For all SOFCs shown on FIG. 6, the LSCF film and the YSZ layer were fabricated using PLD.

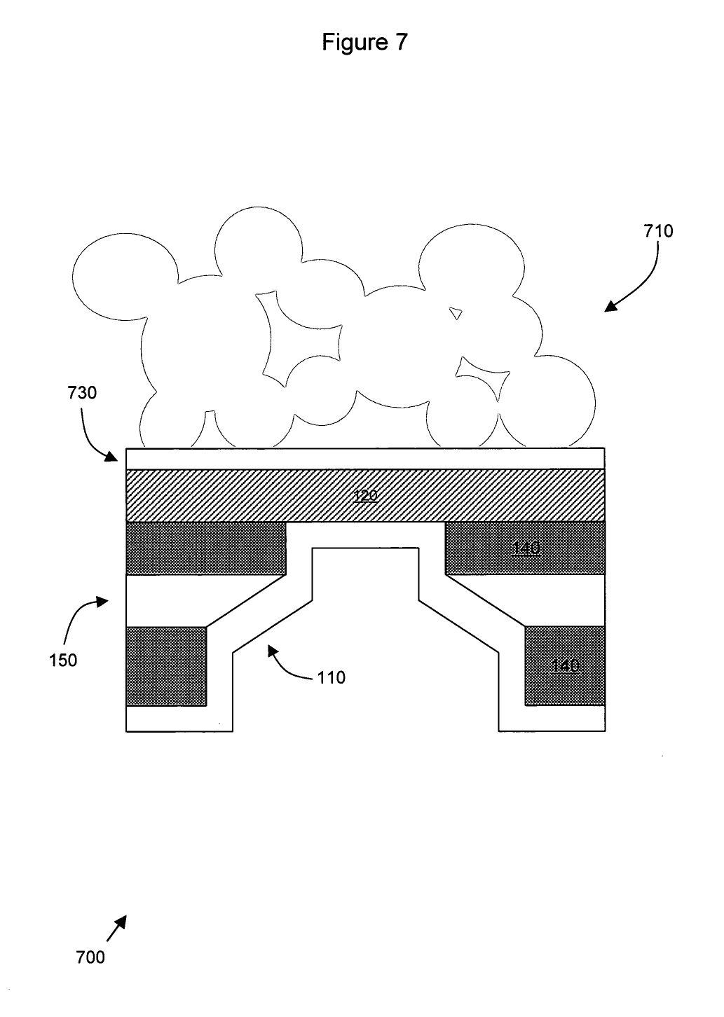

The cathode layer of the SOFC of the present invention can include structures in addition to the MIEC thin film. In particular, FIG. 7 shows a SOFC 700 with a cathode layer that includes a porous platinum layer 710 and a MIEC thin film 730. The MIEC film 730 is situated in between and in contact with the electrolyte layer 120 and the porous platinum layer 710. The porous platinum layer 710 acts as a catalyst for the reduction of oxygen gas and generally decreases the optimal thickness of the MIEC film 730. Due to the presence of the MIEC thin film 730 in the cathode, the platinum layer 710 need not be interconnected for fuel cell operation.

As one of ordinary skill in the art will appreciate, various changes, substitutions, and alterations could be made or otherwise implemented without departing from the principles of the present invention, e.g. the anode can have any geometry and dimension. Accordingly, the scope of the invention should be determined by the following claims and their legal equivalents.

What is claimed is:

1. A solid oxide fuel cell, comprising:
a) an anode;
b) an electrolyte layer, wherein said electrolyte layer has a first surface and a second surface, wherein said first surface of said electrolyte layer is in contact with said anode; and
c) a cathode layer, wherein said cathode layer is in contact with said second surface of said electrolyte layer,
wherein said cathode layer comprises a dense mixed ionic electronic conducting (MIEC) thin film having a thickness T, wherein said thickness of said MIEC film is determined by a minimization of a sum of an electronic resistance Rₑ and an ionic resistance Rᵢ, wherein said electronic resistance is along the plane of said MIEC film, and wherein said ionic resistance is across the thickness of said MIEC film.

2. The fuel cell as set forth in claim 1, wherein said electronic resistance Rₑ decreases with said thickness T and said ionic resistance Rᵢ increases with said thickness T.

3. The fuel cell as set forth in claim 1, wherein said electronic resistance Rₑ is inversely proportional to said thickness T.

4. The fuel cell as set forth in claim 1, wherein said ionic resistance Rᵢ is proportional to said thickness T.

5. The fuel cell as set forth in claim 1, wherein A is an active fuel cell area, D is an average distance traveled by an electron, C is a width of an electron conduction path, σₑ is an electronic conductivity, σᵢ is an ionic conductivity, and
i) Rₑ=D/(TCσₑ) and
ii) Rᵢ=T/(Aσᵢ).

6. The fuel cell as set forth in claim 1, wherein said thickness T ranges from about 10 to about 100 nm.

7. The fuel cell as set forth in claim 6, wherein said thickness T ranges from about 40 to about 50 nm.

8. The fuel cell as set forth in claim 1, wherein said MIEC film comprises a perovskite material.

9. The fuel cell as set forth in claim 8, wherein said perovskite material comprises a lanthanum strontium cobalt iron oxygen (LSCF) material.

10. The fuel cell as set forth in claim 9, wherein said LSCF material has the composition La_{0.6}Sr_{0.4}Co_{0.2}Fe_{0.8}O_{3-δ}.

11. The fuel cell as set forth in claim 1, wherein said electrolyte layer comprises yttria-stabilized zirconia.

12. The fuel cell as set forth in claim 1, wherein said electrolyte layer comprises a thin film having a thickness ranging from about 50 nm to about 200 nm.

13. The fuel cell as set forth in claim 1, wherein said MIEC film is fabricated by pulsed laser deposition.

14. The fuel cell as set forth in claim 1, wherein said cathode layer further comprises a porous platinum layer, wherein said porous platinum layer is in contact with said MIEC film, and wherein said MIEC film is between said electrolyte layer and said porous platinum layer.
